(19) United States
(12) Patent Application Publication
(10) Pub. No.: US 2020/0209668 A1
(43) Pub. Date: Jul. 2, 2020

(54) LIQUID CRYSTAL DISPLAY DEVICE

(71) Applicant: Panasonic Liquid Crystal Display Co., Ltd., Himeji-shi (JP)

(72) Inventors: Kazuhiko TSUDA, Hyogo (JP); Takao IMAOKU, Hyogo (JP); Ikuko IMAJO, Hyogo (JP)

(21) Appl. No.: 16/719,369

(22) Filed: Dec. 18, 2019

(30) Foreign Application Priority Data
Dec. 28, 2018 (JP) 2018-248482

(51) Int. Cl. G02F 1/1347; G02F 1/1335

(52) U.S. Cl. CPC G02F 1/13471; G02F 1/133504; G02F 2202/28; G02F 1/133528; G02F 1/133603

(57) ABSTRACT

A liquid crystal display device includes: a first display panel including a first liquid crystal cell; a second display panel including a second liquid crystal cell; and a bonding member that bonds the first and the second display panels together. The bonding member is made of a photocurable resin. In a section in a thickness direction of the first display panel and parallel to either a longitudinal axis direction or a latitudinal axis direction of the first display panel, a relative curing reaction rate at a central representative point of the bonding member is greater than a relative curing reaction rate at an end representative point of the bonding member. A difference between the relative curing reaction rate at the central representative point of the bonding member and the relative curing reaction rate at the end representative point of the bonding member falls within 4%.

### CROSS-REFERENCE TO RELATED APPLICATION

This application claims priority from Japanese application JP 2018-248482, filed on Dec. 28, 2018. This Japanese application is incorporated herein by reference.

### TECHNICAL FIELD

The present invention relates to a liquid crystal display device.

### BACKGROUND

A liquid crystal display device is used as a display of a television, a monitor or the like. However, the liquid crystal display device has a contrast ratio lower than an organic electro luminescence (EL) display device.

A technique, in which two display panels overlap each other and an image is displayed on each display panel, is conventionally proposed as a technique of improving a contrast ratio of a liquid crystal display device (for example, see Unexamined Japanese Patent Publication No. 2011-076107). A color image is displayed on a front-side (observer-side) display panel in two display panels disposed back and forth, and a black-and-white image is displayed on a rear-side (backlight-side) display panel, thereby improving the contrast ratio.

In this case, the two display panels are bonded together by a bonding member, such as an optically clear adhesive (OCA) or an optically clear resin (OCR), which is made of an ultraviolet curable resin or a thermosetting resin.

### SUMMARY

However, in the liquid crystal display device having the two display panels bonded together by the bonding member, sometimes a frame-shaped luminance unevenness is generated in a periphery of a display screen during energization due to long-term use. As a result, quality of a display image of the liquid crystal display device is degraded.

The present disclosure provides a liquid crystal display device capable of preventing degradation in quality of the display image.

A liquid crystal display device according to a first present disclosure, includes: a first display panel including a first liquid crystal cell; a second display panel including a second liquid crystal cell; and a bonding member that bonds the first display panel and the second display panel together. The bonding member is made of a photocurable resin, in a section along with a thickness direction of the first display panel and along with either a longitudinal axis direction or a latitudinal axis direction of the first display panel, a relative curing reaction rate at a central representative point of the bonding member is greater than a relative curing reaction rate at an end representative point of the bonding member, and a difference between the relative curing reaction rate at the central representative point of the bonding member and the relative curing reaction rate at the end representative point of the bonding member falls within 4%.

A liquid crystal display device according to a second present disclosure, includes: a first display panel including a first liquid crystal cell; a second display panel including a second liquid crystal cell; and a bonding member that bonds the first display panel and the second display panel together. The bonding member is made of a photocurable resin, in a section along with a thickness direction of the first display panel and along with either a longitudinal axis direction or a latitudinal axis direction of the first display panel, a relative curing reaction rate at a central representative point of the bonding member is greater than a relative curing reaction rate at an end representative point of the bonding member, and a value obtained by dividing the relative curing reaction rate at the end representative point of the bonding member by the relative curing reaction rate at the central representative point of the bonding member is greater than or equal to 0.96.

A liquid crystal display device according to a third present disclosure, includes: a first display panel including a first liquid crystal cell; a second display panel including a second liquid crystal cell; and a bonding member that bonds the first display panel and the second display panel together. The bonding member is made of a photocurable resin, in a section along with a thickness direction of the first display panel and along with either a longitudinal axis direction or a latitudinal axis direction of the first display panel, a transition region where a relative curing reaction rate of the bonding member is increased until saturated exists in a curing reaction rate distribution of the bonding member from an end edge toward a center of the bonding member, and a gradient of a straight line connecting a rising start point and a rising end point in the transition region is less than or equal to 0.05%/mm.

A liquid crystal display device according to a fourth present disclosure, includes: a first display panel including a first liquid crystal cell; a second display panel including a second liquid crystal cell; and a bonding member that bonds the first display panel and the second display panel together. The bonding member is made of a photocurable resin, in a section along with a thickness direction of the first display panel and along with either a longitudinal axis direction or a latitudinal axis direction of the first display panel, a transition region where a relative curing reaction rate of the bonding member is increased until saturated exists in a curing reaction rate distribution of the bonding member from an end edge toward a center of the bonding member, and a center of the transition region exists in a range up to 80 mm from the end edge of the bonding member.

### BRIEF DESCRIPTION OF THE DRAWINGS

FIG. 1 is a view illustrating a schematic configuration of a liquid crystal display device according to an exemplary embodiment;

FIG. 2 is a sectional view illustrating a configuration of the liquid crystal display device of the exemplary embodiment;

FIG. 3 is a partially sectional view illustrating the liquid crystal display device of the exemplary embodiment;

FIG. 4 is an enlarged sectional view illustrating the liquid crystal display device of the exemplary embodiment;

FIG. 5 is a view schematically illustrating frame-shaped luminance unevenness generated on a display screen of the liquid crystal display device;

FIG. 6 is a view schematically illustrating a state in which an end region of a bonding member between two display panels bonded together by the bonding member contracts to vary a thickness of a liquid crystal cell when the liquid crystal display device is used for a long time;

A part (a) of FIG. 7 is a diagram illustrating a two-dimensional luminance distribution when the liquid crystal display device in which the frame-shaped luminance unevenness is actually generated is measured with a two-dimensional luminance meter, a part (b) of FIG. 7 is a diagram illustrating a sectional luminance distribution in a line B-B in the part (a) of FIG. 7, and a part (c) of FIG. 7 is a diagram illustrating a simulation result of a change in the thickness in a latitudinal axis direction of the liquid crystal cell in one of display panels when the end region of the bonding member between the two display panels contracts; and

FIG. 8 is a diagram illustrating a distribution of a curing reaction rate in a latitudinal axis direction of the bonding member for the liquid crystal display device in which the frame-shaped luminance unevenness is generated and the liquid crystal display device in which the frame-shaped luminance unevenness is not generated.

### DETAILED DESCRIPTION

Hereinafter, exemplary embodiments will be described with reference to the drawings. The following exemplary embodiments provide comprehensive or specific examples of the present disclosure. Numerical values, shapes, materials, components, disposition positions of the components, connection modes of the components, steps, and order of the steps that are illustrated in the following exemplary embodiments are examples, and therefore are not intended to limit the present disclosure. Among the components in the following exemplary embodiments, the components that are not recited in the independent claims indicating the broadest concept are described as an optional component.

The drawings are schematic diagrams, and not necessarily strictly illustrated. In the drawings, substantially the same configuration is designated by the same reference numerals, and overlapping description will be omitted or simplified.

### Exemplary Embodiment

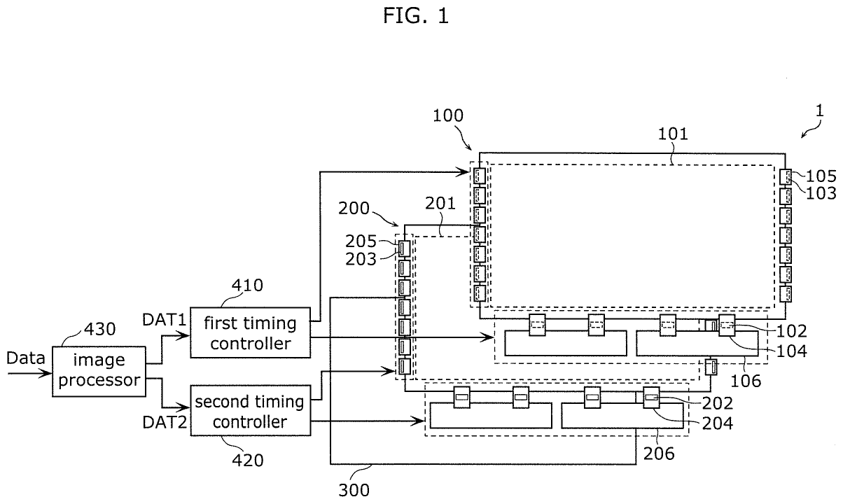

Liquid crystal display device 1 according to an exemplary embodiment will be described below with reference to FIG. 1. FIG. 1 is a view illustrating a schematic configuration of liquid crystal display device 1 of the exemplary embodiment.

Liquid crystal display device 1 is an example of an image display device configured by superimposing a plurality of display panels each including liquid crystal cells, and displays an image (video) of a still image or a moving image.

As illustrated in FIG. 1, liquid crystal display device 1 of the exemplary embodiment includes first display panel 100 disposed at a position (front side) close to an observer and second display panel 200 disposed at a position (rear side) farther away from the observer than first display panel 100 as the plurality of display panels.

Liquid crystal display device 1 also includes backlight 300 disposed on the rear side of first display panel 100 and second display panel 200. Specifically, backlight 300 is disposed on the rear side of second display panel 200.

First display panel 100 is a main panel that displays an image visually recognized by a user. In the exemplary embodiment, first display panel 100 displays a color image. First source driver 102 and first gate driver 103 are provided in first display panel 100 in order to display the color image corresponding to an input video signal on first image display region 101 (active region).

Specifically, first source FPC (Flexible Printed Circuit) 104 on which first source driver 102 is mounted and first gate FPC 105 on which first gate driver 103 is mounted are connected to the liquid crystal cell of first display panel 100.

First circuit board 106 is connected to a portion of first source FPC 104, the portion being one on an opposite side to first display panel 100. First circuit board 106 is a printed circuit board (PCB) having a substantially rectangular plate shape, and a plurality of electronic components are mounted on first circuit board 106. First circuit board 106 has a function of transmitting various signals output from first timing controller 410 to first source driver 102 mounted on first source FPC 104.

When the color image is displayed in first image display region 101 of first display panel 100, various signals output from first timing controller 410 are input to first source driver 102 and first gate driver 103.

Second display panel 200 is a sub-panel disposed on a back surface side of first display panel 100. In the exemplary embodiment, second display panel 200 displays a monochrome image (black-and-white image) of an image corresponding to the color image displayed on first display panel 100 in synchronization with the color image. Second source driver 202 and second gate driver 203 are provided on second display panel 200 in order to display a monochrome image corresponding to the input video signal on second image display region 201.

Specifically, second source FPC 204 on which second source driver 202 is mounted and second gate FPC 205 on which second gate driver 203 is mounted are connected to the liquid crystal cell of second display panel 200.

Second circuit board 206 is connected to a portion of second source FPC 204, the portion being one on the opposite side to second display panel 200. Second circuit board 206 is a printed circuit board (PCB) having a substantially rectangular plate shape, and a plurality of electronic components are mounted on second circuit board 206. Second circuit board 206 has a function of transmitting various signals output from second timing controller 420 to second source driver 202 mounted on second source FPC 204.

When the monochrome image is displayed in second image display region 201 of second display panel 200, various signals output from second timing controller 420 are input to second source driver 202 and second gate driver 203.

First image display region 101 and second image display region 201 include a plurality of pixels arranged in a matrix form. A number of pixels in first image display region 101 and a number of pixels in second image display region 201 may be identical or different.

For example, driving systems of first display panel 100 and second display panel 200 are a lateral electric field system such as an in-plane switching (IPS) system or a fringe field switching (FFS) system. However, the driving system is not limited to the lateral electric field system, but may be a vertical alignment (VA) system or a twisted nematic (TN) system.

Backlight 300 is a light source unit disposed on the back surface side of first display panel 100 and second display panel 200, and emits light toward first display panel 100 and second display panel 200. In the exemplary embodiment, backlight 300 is a surface light source unit that uniformly emits diffused light (scattered light) having a planar shape.

For example, backlight 300 is a light emitting diode (LED) backlight in which an LED is used as a light source. However, backlight 300 is not limited to the LED backlight. In the exemplary embodiment, backlight 300 is of a direct type. However, backlight 300 may be of an edge type. A specific configuration of backlight 300 will be described later.

Liquid crystal display device 1 further includes image processor 430 that outputs image data to first timing controller 410 and second timing controller 420.

Image processor 430 receives input video signal Data transmitted from an external system (not illustrated), performs image processing on input video signal Data, outputs first image data DAT1 to first timing controller 410, and outputs second image data DAT2 to second timing controller 420. Image processor 430 also outputs a control signal (not illustrated in FIG. 1) such as a synchronizing signal to first timing controller 410 and second timing controller 420. First image data DAT1 is image data used to display the color image, and second image data DAT2 is image data used to display the monochrome image.

In liquid crystal display device 1 of the exemplary embodiment, the image is displayed while two display panels of first display panel 100 and second display panel 200 are superimposed on each other, so that black can be made distinct. Consequently, the image having high contrast ratio can be displayed.

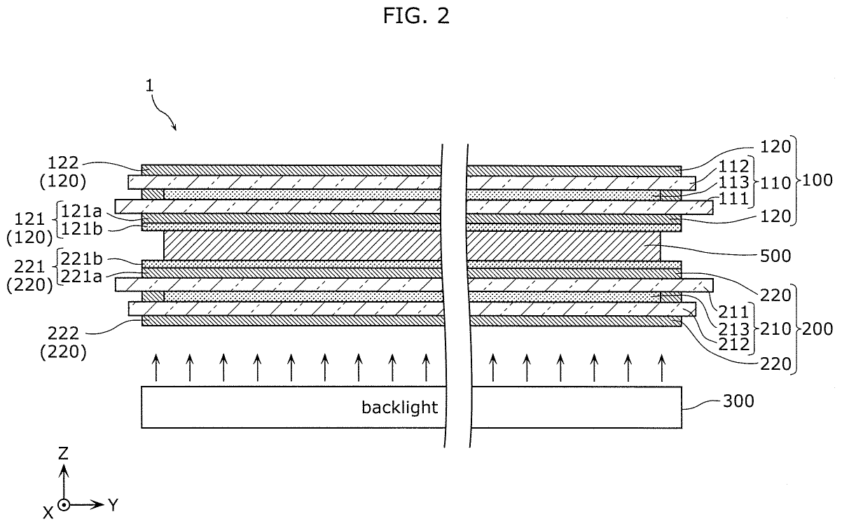

Detailed structures of first display panel 100 and second display panel 200 will be described below with reference to FIG. 2. FIG. 2 is a sectional view illustrating a configuration of liquid crystal display device 1 of the exemplary embodiment.

As illustrated in FIG. 2, liquid crystal display device 1 includes first display panel 100, second display panel 200, and bonding member 500 bonding first display panel 100 and second display panel 200 together. That is, first display panel 100 and second display panel 200 are bonded together by bonding member 500.

First display panel 100 includes first liquid crystal cell 110 and a pair of first polarizing plates 120 sandwiching first liquid crystal cell 110.

First liquid crystal cell 110 includes first thin film transistor (TFT) substrate 111, first counter substrate 112 opposed to first TFT substrate 111, and first liquid crystal layer 113 disposed between first TFT substrate 111 and first counter substrate 112. In the exemplary embodiment, first liquid crystal cell 110 is disposed such that first counter substrate 112 is located in front of first TFT substrate 111.

First TFT substrate 111 is a substrate in which a TFT layer (not illustrated) is formed on a transparent substrate such as a glass substrate. A TFT provided corresponding to each of the pixels arranged in a matrix form and wiring used to drive the TFT are formed in the TFT layer. A pixel electrode used to apply voltage to first liquid crystal layer 113 is formed on a planarization layer of the TFT layer.

First counter substrate 112 is a color filter (CF) substrate in which a color filter layer is formed as a pixel formation layer on a transparent substrate such as a glass substrate. The pixel formation layer of first counter substrate 112 includes a black matrix (black portion) and a color filter (colored portion). For example, the black matrix is formed into a lattice shape or a stripe shape, and a plurality of matrix-shaped openings constituting pixels are formed in the black matrix. A color filter is formed in each opening of the black matrix. That is, the black matrix surrounds the color filter. For example, each color filter is a red color filter, a green color filter, or a blue color filter. The color filter of each color corresponds to each pixel. An overcoat layer is formed so as to cover the pixel formation layer. An alignment film is formed on the surface of the overcoat layer.

First liquid crystal layer 113 is sealed between first TFT substrate 111 and first counter substrate 112. Specifically, first liquid crystal layer 113 is sealed between the alignment film formed on first TFT substrate 111 and the alignment film formed on first counter substrate 112. The liquid crystal material of first liquid crystal layer 113 can appropriately be selected according to the driving system. For example, a thickness (cell gap) of first liquid crystal layer 113 ranges from 2.5 μm to 6 μm. However, the thickness is not limited the range.

The pair of first polarizing plates 120 is constructed with bonding-side first polarizing plate 121 bonded to a surface of first liquid crystal cell 110 on the side of bonding member 500 (the side of second liquid crystal cell 210) and non-bonding-side first polarizing plate 122 bonded to the surface of first liquid crystal cell 110 on the opposite side to bonding member 500.

Specifically, bonding-side first polarizing plate 121 is bonded to the surface of first TFT substrate 111 of first liquid crystal cell 110, and bonded to bonding member 500. On the other hand, non-bonding-side first polarizing plate 122 is bonded to the surface of first counter substrate 112 of first liquid crystal cell 110.

The pair of first polarizing plates 120 (bonding-side first polarizing plate 121 and non-bonding-side first polarizing plate 122) are disposed such that polarization directions of first polarizing plates 120 are orthogonal to each other. That is, the pair of first polarizing plates 120 is disposed in a crossed-Nicols state.

For example, each of the pair of first polarizing plates 120 is a sheet-shaped polarizing film made of a resin material. In the exemplary embodiment, bonding-side first polarizing plate 121 bonded to bonding member 500 in the pair of first polarizing plates 120 includes polarizer 121a and light diffusion adhesive layer 121b disposed on the side of bonding member 500 with respect to polarizer 121a. Each of polarizer 121a and light diffusion adhesive layer 121b is supported by a transparent resin film such as a triacetylcellulose (TAC) film. On the other hand, non-bonding-side first polarizing plate 122 that is not bonded to bonding member 500 in the pair of first polarizing plates 120 includes the polarizer and the TAC similarly to bonding-side first polarizing plate 121, but does not include the light diffusion adhesive layer.

Each of the pair of first polarizing plates 120 may include a transparent protective film as an outermost layer. One of the pair of first polarizing plates 120 may include a phase-difference plate (phase-difference film).

Second display panel 200 includes second liquid crystal cell 210 and a pair of second polarizing plates 220 sandwiching second liquid crystal cell 210.

Second liquid crystal cell 210 includes second TFT substrate 211, second counter substrate 212 opposed to second TFT substrate 211, and second liquid crystal layer 213 disposed between second TFT substrate 211 and second counter substrate 212. In the exemplary embodiment, second liquid crystal cell 210 is disposed such that second TFT substrate 211 is located in front of second counter substrate 212. Alternatively, second counter substrate 212 may be disposed in front of second TFT substrate 211.

Second TFT substrate 211 has the same configuration as that of first TFT substrate 111, and is a substrate in which a TFT layer (not illustrated) is formed on a transparent substrate such as a glass substrate.

Second counter substrate 212 is a substrate in which a pixel formation layer is formed on a transparent substrate such as a glass substrate. The pixel formation layer of second counter substrate 212 includes a black matrix in which a plurality of openings in a matrix form constituting pixels are formed. An overcoat layer is formed so as to cover the pixel formation layer of second counter substrate 212. An alignment film is formed on the surface of the overcoat layer. In the exemplary embodiment, because second display panel 200 displays the monochrome image, the color filter is not formed in the pixel formation layer of second counter substrate 212. Thus, the overcoat layer is filled in the opening of the black matrix of the pixel formation layer of second counter substrate 212.

Second liquid crystal layer 213 is sealed between second TFT substrate 211 and second counter substrate 212. Specifically, second liquid crystal layer 213 is sealed between the alignment film formed on second TFT substrate 211 and the alignment film formed on second counter substrate 212. The liquid crystal material of second liquid crystal layer 213 can appropriately be selected according to the driving system. For example, similarly to first liquid crystal layer 113, the thickness (cell gap) of second liquid crystal layer 213 ranges from 2.5 μm to 6 μm. However, the thickness is not limited the range.

The pair of second polarizing plates 220 sandwiching second liquid crystal cell 210 has the configuration similar to that of first polarizing plate 120. The pair of second polarizing plates 220 is formed by bonding-side second polarizing plate 221 bonded to the surface of second liquid crystal cell 210 on the side of bonding member 500 (the side of first liquid crystal cell 110) and non-bonding-side second polarizing plate 222 bonded to the surface of second liquid crystal cell 210 on the opposite side to bonding member 500.

Specifically, bonding-side second polarizing plate 221 is bonded to the surface of second TFT substrate 211 of second liquid crystal cell 210, and bonded to bonding member 500. On the other hand, non-bonding-side second polarizing plate 222 is attached to the surface of second counter substrate 212 of second liquid crystal cell 210.

The pair of second polarizing plates 220 (bonding-side second polarizing plate 221 and non-bonding-side second polarizing plate 222) is disposed such that the polarization directions of second polarizing plates 220 are orthogonal to each other. That is, the pair of second polarizing plates 220 is disposed in the crossed-Nicols state.

For example, each of the pair of second polarizing plates 220 is a sheet-shaped polarizing film made of a resin material. In the exemplary embodiment, bonding-side second polarizing plate 221 bonded to bonding member 500 in the pair of second polarizing plates 220 includes polarizer 221a and light diffusion adhesive layer 221b disposed on the side of bonding member 500 with respect to polarizer 221a. Each of polarizer 221a and light diffusion adhesive layer 221b is supported by a transparent resin film such as a TAC film. On the other hand, non-bonding-side second polarizing plate 222 that is not bonded to bonding member 500 in the pair of second polarizing plates 220 includes the polarizer and the TAC similarly to bonding-side second polarizing plate 221, but does not include the light diffusion adhesive layer.

Each of the pair of second polarizing plates 220 may include a transparent protective film as an outermost layer. One of the pair of second polarizing plates 220 may include a phase-difference plate (phase-difference film).

Bonding member 500 bonds first display panel 100 and second display panel 200 together. Specifically, bonding member 500 bonds bonding-side first polarizing plate 121 of first display panel 100 and bonding-side second polarizing plate 221 of second display panel 200 together. In the exemplary embodiment, bonding member 500 is in contact with light diffusion adhesive layer 121b of bonding-side first polarizing plate 121, and is in contact with light diffusion adhesive layer 221b of bonding-side second polarizing plate 221.

That is, bonding member 500 is an adhesive layer bonding first display panel 100 and second display panel 200 together. Specifically, bonding member 500 is a bonding sheet made of an optically clear adhesive (OCA).

For example, bonding member 500 is made of a photocurable resin such as an ultraviolet curable resin. Examples of the photocurable resin include acryl-based, silicone-based, urethane-based, polyester-based, and epoxy-based compounds. In the exemplary embodiment, bonding member 500 is made of an acrylic ultraviolet curable resin. As used herein, the “photocurable resin” means a resin composition that can be cured by exposure. The “exposure” means irradiation with light such as an ultraviolet ray.

Bonding member 500 may be provided in such a manner that a sheet-shaped photocurable resin composition obtained by previous solidification is exposed while inserted between first display panel 100 and second display panel 200, or in such a manner that a liquid photocurable resin composition applied onto one of first display panel 100 and second display panel 200 is exposed while the other of first display panel 100 and second display panel 200 is laminated on the one of first display panel 100 and second display panel 200.

Because the photocurable resin does not need to be heated to remove the solvent, a solventless type photocurable resin is preferably used as the photocurable resin. The “solvent-free type” means that the solvent is not contained or a content of the solvent is less than or equal to 5% by weight of a total weight (100% by weight) of the curable resin. The “solvent” means a liquid (volatile diluent) having a boiling point of 150° C. or lower. Because a drying process can be eliminated using the photocurable resin that does not contain the solvent, preferably the photocurable resin does not contain the solvent.

The photocurable resin is cured at a low temperature, and has a faster curing speed than that of the thermosetting resin. For this reason, the use of the photocurable resin can bond first display panel 100 and second display panel 200 together at a low temperature in a short time.

Typically curable resins such as the photocurable resin contain a curable compound having a curable group and a polymerization initiator (reaction initiator). Other compounds except for the polymerization initiator may be contained in the curable resin as needed. Examples of other compounds include additives such as a tackifier, a plasticizer, and a stabilizer.

First display panel 100 and second display panel 200 bonded by bonding member 500 are held by a holding member such as a frame together with backlight 300.

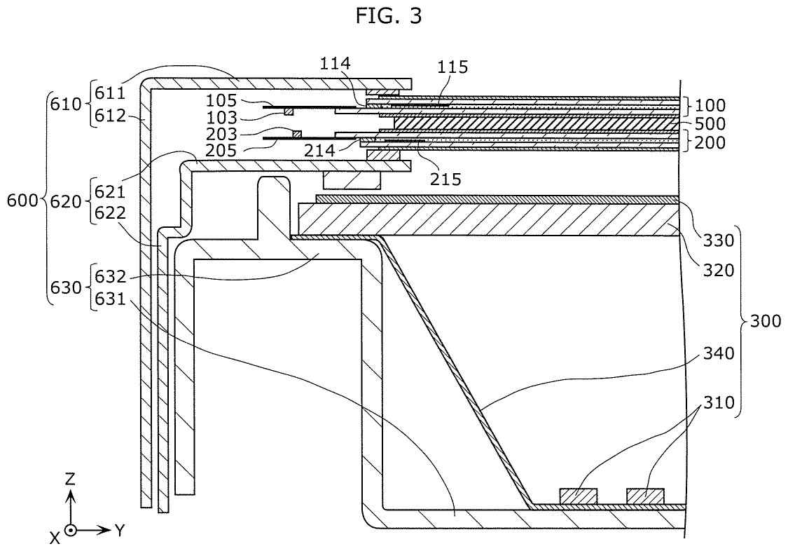

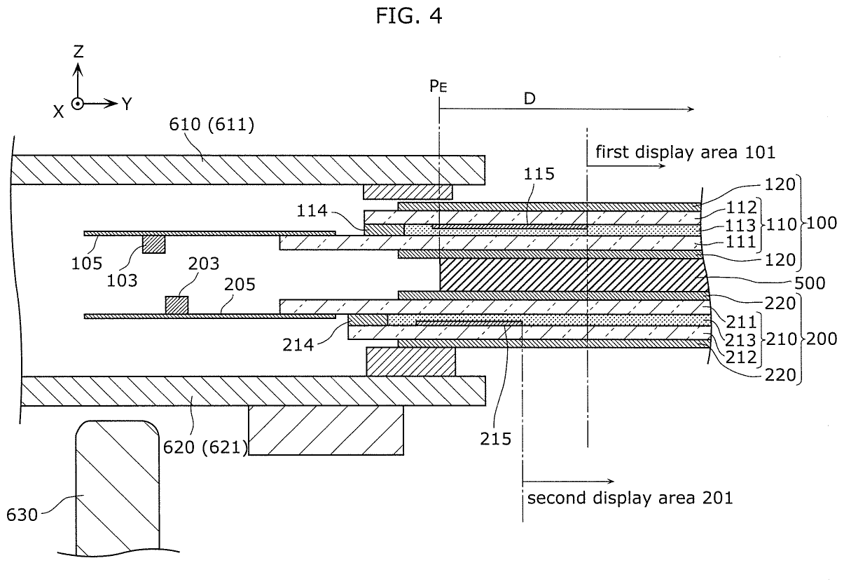

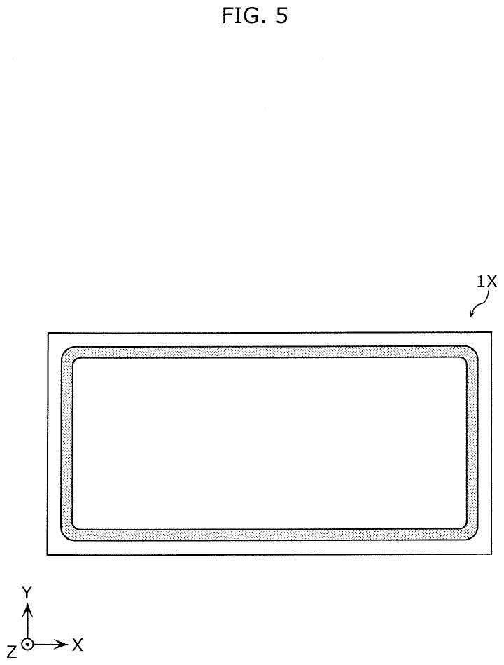

Detailed structures of first display panel 100, second display panel 200, and backlight 300 and holding structures of first display panel 100, second display panel 200, and backlight 300 will be described with reference to FIGS. 3 and 4. FIG. 3 is a partially sectional view illustrating liquid crystal display device 1 of the exemplary embodiment. FIG. 4 is an enlarged sectional view of FIG. 3. A gate-driver-side end region where first gate FPC 105 and second gate FPC 205 are provided is illustrated in FIGS. 3 and 4.

As illustrated in FIGS. 3 and 4, first display panel 100, second display panel 200, and backlight 300 are held by frame 600. Frame 600 is a holding member holding first display panel 100, second display panel 200, and backlight 300. In the exemplary embodiment, frame 600 includes upper frame 610 (first frame), middle frame 620 (second frame), and lower frame 630 (third frame).

First liquid crystal cell 110 of first display panel 100 includes first sealing member 114 and first marginal light shielding layer 115 in addition to first TFT substrate 111, first counter substrate 112, and first liquid crystal layer 113.

First sealing member 114 seals first liquid crystal layer 113 between first TFT substrate 111 and first counter substrate 112. For example, first sealing member 114 is formed into a frame shape along outer peripheral ends of first TFT substrate 111 and first counter substrate 112. For example, first sealing member 114 has a width of about 1 mm to about 2 mm, but the present disclosure is not limited thereto.

First marginal light shielding layer 115 is formed in a region around first image display region 101 (active region). In the exemplary embodiment, first marginal light shielding layer 115 is formed on first counter substrate 112. For example, first marginal light shielding layer 115 can be made of a material similar to that of a black matrix formed in first image display region 101. For example, first marginal light shielding layer 115 has a width of about 4 mm to about 5 mm, but the present disclosure is not limited thereto.

Similarly, second liquid crystal cell 210 of second display panel 200 includes second sealing member 214 and second marginal light shielding layer 215 in addition to second TFT substrate 211, second counter substrate 212, and second liquid crystal layer 213.

Second sealing member 214 seals second liquid crystal layer 213 between second TFT substrate 211 and second counter substrate 212. For example, second sealing member 214 is formed into the frame shape along outer peripheral ends of second TFT substrate 211 and second counter substrate 212. For example, second sealing member 214 has the same width as first sealing member 114 of first liquid crystal cell 110, and the width ranges from about 1 mm to about 2 mm, but the present disclosure is not limited thereto.

In the exemplary embodiment, second sealing member 214 is formed outside first sealing member 114 of first liquid crystal cell 110. Specifically, an outside end of second sealing member 214 is located outside an outside end of first sealing member 114, and an inside end of second sealing member 214 is located outside an inside end of first sealing member 114.

Second marginal light shielding layer 215 is formed in a region around second image display region 201 (active region). In the exemplary embodiment, second marginal light shielding layer 215 is formed on second counter substrate 212. For example, second marginal light shielding layer 215 can be made of the same material as the black matrix formed in second image display region 201. Second marginal light shielding layer 215 is narrower than first marginal light shielding layer 115. As an example, the width of the second marginal light shielding layer 215 ranges from about 3 mm to about 4 mm.

In the exemplary embodiment, second marginal light shielding layer 215 is formed outside first marginal light shielding layer 115 of first liquid crystal cell 110. Specifically, an outside end of second marginal light shielding layer 215 is located outside an outside end of first marginal light shielding layer 115, and an inside end of second marginal light shielding layer 215 is located outside an inside end of first marginal light shielding layer 115. In this way, the inside end of second marginal light shielding layer 215 is located outside the inside end of first marginal light shielding layer 115, which prevents degradation in quality of a display image in the end region when the display screen of liquid crystal display device 1 is obliquely viewed.

Backlight 300 includes a plurality of LEDs 310, transparent substrate 320, optical sheet 330, and reflecting plate 340.

Each of the plurality of LEDs 310 is an example of a light emitting element. For example, a white LED light source emitting white light can be used as LED 310. In the exemplary embodiment, backlight 300 is a direct-type backlight, and the plurality of LEDs 310 are two-dimensionally arranged. Specifically, the plurality of LEDs 310 are arranged into a matrix form at a bottom of main body 631 of lower frame 630. In the exemplary embodiment, the plurality of LEDs 310 are disposed on a bottom of reflecting plate 340 disposed in a recess of lower frame 630.

Transparent substrate 320 and optical sheet 330 are disposed in front of LED 310 (light emitting side). That is, transparent substrate 320 and optical sheet 330 are opposite to main body 631 of lower frame 630.

For example, transparent substrate 320 is a glass plate transparent to visible light. In this case, tempered glass having excellent mechanical strength is preferably used as transparent substrate 320. An outer peripheral end portion of transparent substrate 320 is supported by support 632 of lower frame 630.

Optical sheet 330 provides optical action to the light emitted from LED 310. For example, a diffusion plate (diffusion sheet) and/or a prism sheet that diffuses the light emitted from LED 310 can be used as optical sheet 330. For example, optical sheet 330 is a resin sheet made of a resin material. The number of optical sheets 330 may be one or plural.

As described above, frame 600 includes upper frame 610, middle frame 620, and lower frame 630. For example, upper frame 610, middle frame 620, and lower frame 630 are fixed to one another by screws.

Upper frame 610 that is of the first frame is a front frame disposed on an upper side in frame 600. Upper frame 610 includes first bezel 611 covering a peripheral portion of first display panel 100 and first sidewall 612 extending from first bezel 611 to the side of lower frame 630.

Middle frame 620 that is of the second frame is disposed between upper frame 610 and lower frame 630. Middle frame 620 supports first display panel 100 and second display panel 200 from the side of backlight 300. Middle frame 620 includes second bezel 621 covering a peripheral portion of second display panel 200 and a second sidewall 622 extending from second bezel 621 to the side of lower frame 630.

Lower frame 630 that is of the third frame is a rear frame disposed on the back surface side in frame 600. Lower frame 630 includes main body 631 that accommodates LED 310 of backlight 300 therein and support 632 that supports transparent substrate 320 and reflecting plate 340 of backlight 300.

Effects of liquid crystal display device 1 of the exemplary embodiment will be described below including circumstances leading to the technique of the present disclosure.

When the liquid crystal display device having the two display panels bonded together by the bonding member made of the photocurable resin is used for a long time, there is a risk of generating the frame-shaped luminance unevenness in the peripheral portion of the display screen during energization. For example, when liquid crystal display device 1X was used for 2000 hours, as illustrated by hatching in FIG. 5, the frame-shaped luminance unevenness was generated in the peripheral portion of the display screen of liquid crystal display device 1X. As described above, when the frame-shaped luminance unevenness is generated in liquid crystal display device 1X, the quality of the display image is degraded.

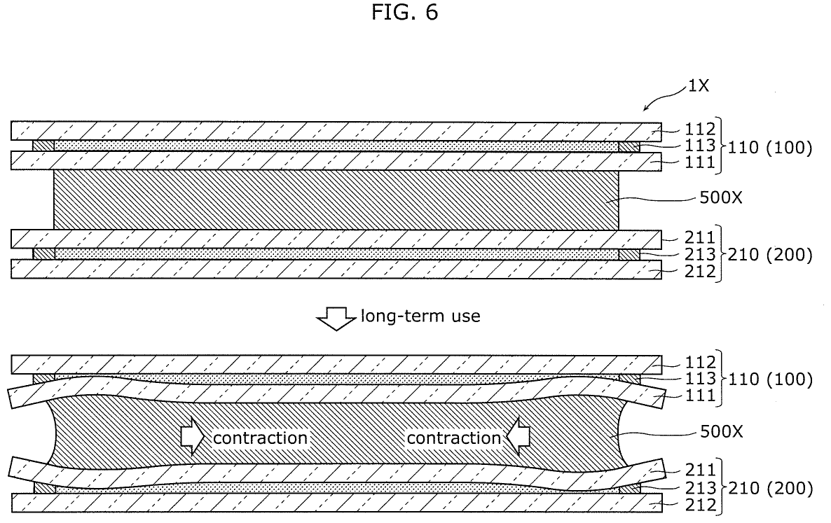

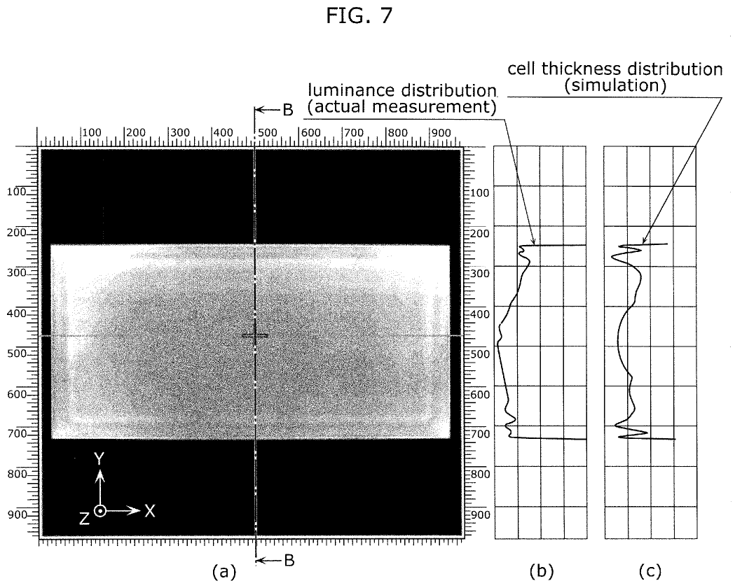

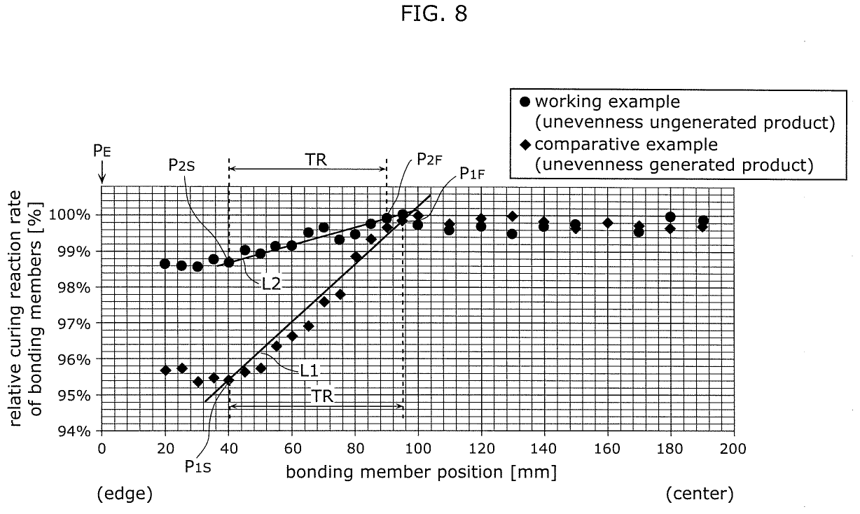

The inventors of the present disclosure studied a cause of degradation in quality of the display image, and found that bonding member 500X between first display panel 100 and second display panel 200 contracts in a region except for the peripheral edge by the long-time use of liquid crystal display device 1X as illustrated in FIG. 6, and tensile stress toward the center is generated in first TFT substrate 111 of first display panel 100 and second TFT substrate 211 of second display panel 200. The inventors estimated that first TFT substrate 111 of first display panel 100 and second TFT substrate 211 of second display panel 200 were distorted due to the tensile stress to vary the thickness (cell thickness) of the liquid crystal cell in the end regions of first display panel 100 and second display panel 200, and therefore the frame-shaped luminance unevenness was generated. That is, the inventors estimated that the generation of the frame-shaped luminance unevenness was caused by a change in thickness in the end region of the liquid crystal cell of the display panel in the liquid crystal display device. In FIG. 6, the polarizing plate is omitted.

Based on the estimation, the inventors measured the luminance of the liquid crystal display device in which the frame-shaped luminance unevenness was actually generated, and performed a simulation on the variation in thickness of the liquid crystal cell. FIG. 7 illustrates a simulation result.

A part (a) of FIG. 7 is a diagram illustrating a two-dimensional luminance distribution when the liquid crystal display device in which the frame-shaped luminance unevenness is actually generated is measured with a two-dimensional luminance meter, and a part (b) of FIG. 7 is a diagram illustrating a sectional luminance distribution along a line B-B (latitudinal axis direction) in the part (a) of FIG. 7. A part (c) of FIG. 7 is a diagram illustrating the change in thickness (cell thickness distribution) in the latitudinal axis direction of the liquid crystal cell of one of the display panels when an end region of the bonding member (OCA) between the two display panels contracts.

As can be seen by comparison between the part (b) of FIG. 7 and the part (c) of FIG. 7, the luminance distribution and the cell thickness distribution are almost matched with each other. That is, it is considered that the frame-shaped luminance unevenness is generated as a result of varying the thickness of the liquid crystal cell of the display panel due to the contraction in the end region of the bonding member between the two display panels.

Based on the result, the inventors further studied the cause of the contraction in the end region of the bonding member. Specifically, the inventors paid attention to the fact that the resin material constituting the bonding member is the photocurable resin, and considered that the contraction in the end region of the bonding member was caused by the photocurable resin.

As a result, the inventors found that the contraction in the end region of the bonding member was caused by a distribution of a curing reaction rate of the photocurable resin. Although the reason why the distribution of the curing reaction rate is generated is not necessarily clear, an additional reaction of the photocurable resin is generated by light from the backlight when the liquid crystal display device having the two display panels bonded together by the bonding member made of the photocurable resin is used for a long time.

As a result of intensive studies based on this knowledge, the inventors paid an attention on the fact that a difference in curing reaction rate of the photocurable resin is generated between the end region and the central region of the bonding member in the liquid crystal display device in which the two display panels are bonded together by the bonding member, and conceived an idea that the degradation in quality of the display image due to the frame-shaped luminance unevenness can be prevented by setting a ratio between the curing reaction rate in the central region of the bonding member and the curing reaction rate in the end region of the bonding member within a predetermined range.

The inventors measured the distribution of the curing reaction rate of the bonding member for a liquid crystal display device in which the frame-shaped luminance unevenness was actually generated, and for a liquid crystal display device in which the frame-shaped luminance unevenness was not generated, each liquid crystal display device having two display panels bonded together by the bonding member made of the photocurable resin. FIG. 8 illustrates the results.

FIG. 8 illustrates the distribution of the curing reaction rate in the latitudinal axis direction of the bonding member for the liquid crystal display device in which the frame-shaped luminance unevenness was generated (hereinafter referred to as an “unevenness-generated product”) and the liquid crystal display device in which the frame-shaped luminance unevenness was not generated (hereinafter referred to as an “unevenness-free product”). In FIG. 8, the liquid crystal display device having the two display panels bonded together by the bonding member made of an ultraviolet curable resin was used for both the unevenness-generated product and the unevenness-free product.

In FIG. 8, a vertical axis indicates the curing reaction rate of the bonding member. In FIG. 8, the curing reaction rate of the bonding member in the unevenness-generated product and the curing reaction rate of the bonding member in the unevenness-free product are expressed by not an actual measurement value (absolute value), but a relative value called a relative curing reaction rate. In FIG. 8, a horizontal axis indicates a position from the end edge of the bonding member in the latitudinal axis direction. Specifically, the horizontal axis indicates distance D from end edge PE of bonding member 500 in FIG. 4. The relative curing reaction rate is a value obtained by dividing the curing reaction rate at each point measured in the section to be measured by the curing reaction rate having the largest value in the section in terms of percentage. For example, in the unevenness-free product in the section in FIG. 8, the point indicating the largest curing reaction rate in the section is the point of 95 mm, and the relative curing reaction rate at each point is a value obtained by dividing the measured curing reaction rate at a corresponding point by the curing reaction rate at the point of 95 mm in terms of percentage.

The unevenness-generated product is a product in which the liquid crystal display device is used for 3000 hours, and the unevenness-free product is a product in which the liquid crystal display device is used for 2000 hours. FIG. 8 illustrates the relative curing reaction rate of the bonding member in the latitudinal axis direction, and the same result as the result in FIG. 8 was obtained for the relative curing reaction rate of the bonding member in the longitudinal axis direction.

The inventors studied based on the results of the curing reaction rate distribution in FIG. 8, and found that the frame-shaped luminance unevenness during the energization can be prevented when a difference between the relative curing reaction rate at a central representative point of bonding member 500 and the relative curing reaction rate at an end representative point of bonding member 500 is at least less than or equal to 4%, or when a value obtained by dividing the relative curing reaction rate at the end representative point of bonding member 500 by the relative curing reaction rate at the central representative point of bonding member 500 is greater than or equal to 0.96, in the section in the thickness direction of first display panel 100 or second display panel 200 and parallel to either the longitudinal axis direction or the latitudinal axis direction of first display panel 100 or second display panel 200 in liquid crystal display device 1 in FIGS. 1 to 4.

As used herein, the central representative point of bonding member 500 means the position that is the center of bonding member 500 in the section, and in FIG. 8, the central representative point is the position that becomes the center of bonding member 500 in the section parallel to the latitudinal axis direction of first display panel 100 or second display panel 200. The end representative point of bonding member 500 means the position that is shifted to the central side (inside) by 10% from the end edge of bonding member 500 in the section, and in FIG. 8, because a length in the latitudinal axis direction of bonding member 500 is 385.8 mm, the end representative point is the position that is shifted to the central side by 38.6 mm from a short edge of bonding member 500 in the section parallel to the latitudinal axis direction of first display panel 100 or second display panel 200.

That is, in liquid crystal display device 1 in which the relative curing reaction rate in the central region of bonding member 500 is larger than the relative curing reaction rate in the end region of bonding member 500, when the difference between the relative curing reaction rate at the central representative point of bonding member 500 and the relative curing reaction rate at the end representative point of bonding member 500 is at least less than or equal to 4%, or when the value obtained by dividing the relative curing reaction rate at the end representative point of bonding member 500 by the relative curing reaction rate at the central representative point of bonding member 500 is greater than or equal to 0.96, the variation in thickness of first liquid crystal cell 110 or second liquid crystal cell 210 due to a volume contraction difference between the central region and the end region in bonding member 500 is prevented, and the generation of the frame-shaped luminance unevenness can be prevented during the energization of liquid crystal display device 1.

In liquid crystal display device 1 of the exemplary embodiment, preferably the difference between the relative curing reaction rate at the central representative point of bonding member 500 and the relative curing reaction rate at the end representative point of bonding member 500 falls within 2%. Alternatively, preferably a value obtained by dividing the relative curing reaction rate at the end representative point of bonding member 500 by the relative curing reaction rate at the central representative point of bonding member 500 is greater than or equal to 0.98.

With this, the variation in thickness of first liquid crystal cell 110 or second liquid crystal cell 210 due to the volume contraction difference between the central region and the end region in bonding member 500 can further be prevented. Thus, the generation of frame-shaped luminance unevenness during the energization of liquid crystal display device 1 can further be prevented.

As illustrated in FIG. 8, a transition region TR where the relative curing reaction rate of bonding member 500 is increased until saturated exists in the curing reaction rate distribution of bonding member 500 from the end edge (P_{E}) to the center of bonding member 500. Transition region TR is a region from when the relative curing reaction rate of bonding member 500 in the curing reaction rate distribution starts to rise until becoming substantially constant, and appears in the end region of bonding member 500.

At this point, it can be considered that the reaction rate is saturated (a region until the reaction rate becomes substantially constant) when a value obtained by diving the relative curing reaction rate of bonding member 500 at a certain point by the relative curing reaction rate of bonding member 500 at a point closer to a central side than the certain point by 5 mm ranges from 0.9990 to 1.0010, inclusive, and it can be considered that the certain point is the end (rising end point (to be described later)) on the central side of transition region TR.

For example, regardless of a size (screen size) of the display region of liquid crystal display device 1, the center of transition region TR of the curing reaction rate distribution is located in first image display region 101 of first display panel 100 and second image display region 201 of second display panel 200, and exists within a range of 80 mm from the end edge (P_{E}) of bonding member 500, namely, within a range of 20% from the end edge (P_{E}) of bonding member 500. The frame-shaped luminance unevenness generated during the energization of liquid crystal display device is generated near the center of transition region TR.

Transition region TR of the unevenness-generated product and transition region TR of the unevenness-free product may be located at the same position or different positions. That is, in transition region TR of the unevenness-generated product and transition region TR of the unevenness-free product, rising start points or rising end points of the curing reaction rate may be located at the same position or different positions.

As a result of studying a plurality of unevenness-generated products, a gradient of the straight line connecting the rising start point and the rising end point in transition region TR of the curing reaction rate distribution in the unevenness-generated product generally exceeded 0.05%/mm. The gradient of straight line L1 connecting the rising start point (P_{1S}) and the rising end point (P_{1F}) in transition region TR of the curing reaction rate distribution for the unevenness-generated product in FIG. 8 is about 0.08%/mm.

Conversely, when a plurality of unevenness-free products were studied, the gradient of the straight line connecting the rising start point and the rising end point in transition region TR of the curing reaction rate distribution in the unevenness-free product was almost less than or equal to 0.05%/mm.

Thus, for bonding member 500 in liquid crystal display device 1, preferably the gradient of the straight line connecting the rising start point and the rising end point in transition region TR of the curing reaction rate distribution is less than or equal to 0.05%/mm.

With this, the variation in thickness of first liquid crystal cell 110 or second liquid crystal cell 210 due to the volume contraction difference between the central region and the end region in bonding member 500 can effectively be prevented. Thus, the generation of the frame-shaped luminance unevenness during the energization of liquid crystal display device 1 can effectively be prevented.

In many unevenness-free products, the gradient of the straight line connecting the rising start point and the rising end point in transition region TR of the curing reaction rate distribution was greater than or equal to 0.03%/mm.

Thus, for bonding member 500 in liquid crystal display device 1, preferably the gradient of the straight line connecting the rising start point and the rising end point in transition region TR of the curing reaction rate distribution is less than or equal to 0.03%/mm.

Consequently, the variation in thickness of first liquid crystal cell 110 or second liquid crystal cell 210 due to the volume contraction difference between the central region and the end region in bonding member 500 can more effectively be prevented. Thus, the generation of the frame-shaped luminance unevenness during the energization of liquid crystal display device 1 can more effectively be prevented. The gradient of straight line L2 connecting the rising start point (P_{2S}) and the rising end point (P_{2F}) in transition region TR of the curing reaction rate distribution for the unevenness-free product in FIG. 8 is about 0.02%/mm.

As described above, in liquid crystal display device 1 of the exemplary embodiment, the curing reaction rate distribution of bonding member 500 is set within a desired range, so that the generation of the frame-shaped luminance unevenness can be prevented in the peripheral portion of the display screen. Thus, the degradation in the quality of the display image can be prevented.

### (Modifications)

The liquid crystal display device of the present disclosure is described above based on the exemplary embodiment, but the present disclosure is not limited to the exemplary embodiment.

Although bonding member 500 of the exemplary embodiment is made only of a photocurable resin out of a thermosetting resin and a photocurable resin, which are examples of a curable resin, bonding member 500 is not limited to the photocurable resin. Specifically, bonding member 500 may be made of both the thermosetting resin and the photocurable resin.

In the exemplary embodiment, bonding member 500 is constructed with one layer, but may be constructed with a plurality of layers. For example, bonding member 500 may be constructed with a plurality of adhesive layers laminated in a thickness direction.

In the above exemplary embodiment, first display panel 100 displays the color image and second display panel 200 displays the monochrome image. However, the present disclosure is not limited to the exemplary embodiment. For example, first display panel 100 may display the monochrome image and second display panel 200 may display the color image.

The two display panels are used in the exemplary embodiment. However, the present disclosure is not limited to the two display panels. For example, three or more display panels may be used. In this case, the bonding member will be inserted between every two adjacent display panels.

Those skilled in the art will readily appreciate that many modifications are possible in the above exemplary embodiment and variations without materially departing from the novel teachings and advantages of the present disclosure. Accordingly, all such modifications are intended to be included within the scope of the present disclosure.

What is claimed is:

1. A liquid crystal display device comprising:
a first display panel including a first liquid crystal cell;
a second display panel including a second liquid crystal cell; and
a bonding member that bonds the first display panel and the second display panel together,
wherein the bonding member is made of a photocurable resin,
in a section along with a thickness direction of the first display panel and along with either a longitudinal axis direction or a latitudinal axis direction of the first display panel, a relative curing reaction rate at a central representative point of the bonding member is greater than a relative curing reaction rate at an end representative point of the bonding member, and
a difference between the relative curing reaction rate at the central representative point of the bonding member and the relative curing reaction rate at the end representative point of the bonding member falls within 4%.

2. The liquid crystal display device according to claim 1, wherein the difference between the relative curing reaction rate at the central representative point of the bonding member and the relative curing reaction rate at the end representative point of the bonding member falls within 2%.

3. The liquid crystal display device according to claim 1, wherein
a transition region where a relative curing reaction rate of the bonding member is increased until saturated exists in a curing reaction rate distribution of the bonding member from an end edge toward a center of the bonding member, and
a gradient of a straight line connecting a rising start point and a rising end point in the transition region is less than or equal to 0.05%/mm.

4. The liquid crystal display device according to claim 3, wherein the gradient is less than or equal to 0.03%/mm.

5. The liquid crystal display device according to claim 3, wherein a center of the transition region exists in a range up to 80 mm from the end edge of the bonding member.

6. The liquid crystal display device according to claim 1, wherein the photocurable resin is an ultraviolet curable resin.

7. A liquid crystal display device comprising:
a first display panel including a first liquid crystal cell;
a second display panel including a second liquid crystal cell; and
a bonding member that bonds the first display panel and the second display panel together,
wherein the bonding member is made of a photocurable resin,
in a section along with a thickness direction of the first display panel and along with either a longitudinal axis direction or a latitudinal axis direction of the first display panel, a relative curing reaction rate at a central representative point of the bonding member is greater than a relative curing reaction rate at an end representative point of the bonding member, and
a value obtained by dividing the relative curing reaction rate at the end representative point of the bonding member by the relative curing reaction rate at the central representative point of the bonding member is greater than or equal to 0.96.

8. The liquid crystal display device according to claim 7, wherein the value obtained by dividing the relative curing reaction rate at the end representative point of the bonding member by the relative curing reaction rate at the central representative point of the bonding member is greater than or equal to 0.98.

9. The liquid crystal display device according to claim 7, wherein
a transition region where a relative curing reaction rate of the bonding member is increased until saturated exists in a curing reaction rate distribution of the bonding member from an end edge toward a center of the bonding member, and
a gradient of a straight line connecting a rising start point and a rising end point in the transition region is less than or equal to 0.05%/mm.

10. The liquid crystal display device according to claim 9, wherein the gradient is less than or equal to 0.03%/mm.

11. The liquid crystal display device according to claim 9, wherein a center of the transition region exists in a range up to 80 mm from the end edge of the bonding member.

12. The liquid crystal display device according to claim 7, wherein the photocurable resin is an ultraviolet curable resin.

13. A liquid crystal display device comprising:
a first display panel including a first liquid crystal cell;
a second display panel including a second liquid crystal cell; and
a bonding member that bonds the first display panel and the second display panel together,
wherein the bonding member is made of a photocurable resin,
in a section along with a thickness direction of the first display panel and along with either a longitudinal axis direction or a latitudinal axis direction of the first display panel, a transition region where a relative curing reaction rate of the bonding member is increased until saturated exists in a curing reaction rate distribution of the bonding member from an end edge toward a center of the bonding member, and
a center of the transition region exists in a range up to 80 mm from the end edge of the bonding member.

14. The liquid crystal display device according to claim 13, wherein a gradient of a straight line connecting a rising start point and a rising end point in the transition region is less than or equal to 0.05%/mm.
